(19) United States
(12) Patent Application Publication
(10) Pub. No.: US 2026/0350943 A1
(43) Pub. Date: Nov. 5, 2026

(54) VIRTUAL SPACE MANAGEMENT APPARATUS

(71) Applicant: NTT DOCOMO, INC., Tokyo (JP)

(72) Inventors: Naomasa YOSHIDA, Chiyoda-ku (JP); Kazumasa UEDA, Chiyoda-ku (JP); Jiro NEGISHI, Chiyoda-ku (JP); Yohei SATO, Chiyoda-ku (JP)

(73) Assignee: NTT DOCOMO, INC., Tokyo (JP)

(21) Appl. No.: 19/148,053

(22) PCT Filed: Feb. 5, 2024
(86) PCT No.: PCT/JP2024/003659

§ 371 Date: Jul. 15, 2025

(30) Foreign Application Priority Data
Feb. 7, 2023 (JP) 2023-016669

(51) Int. Cl. G06T 19/20; G06F 3/01

(52) U.S. Cl. CPC G06T 19/20; G06F 3/011; G06T 2219/2004

(57) ABSTRACT

A virtual space management apparatus displays on a terminal device used by a user, a virtual space in which images are arranged. The images correspond to works created by creators. The creators include a first creator. The virtual space management apparatus includes: a display controller configured to display in a first region that is a region within the virtual space assigned to the first creator, a first image representing a first work that is one among a first work group created by the first creator; and a detector configured to detect a motion of the user viewing the first image. Based on the motion of the user, the display controller displays in the first region, a second image representing a second work that differs from the first work among the first work group.

### TECHNICAL FIELD

The present invention relates to virtual space management apparatuses.

### BACKGROUND ART

Conventionally, creators show their works to others by exhibiting them in galleries, museums, or other similar facilities (hereinafter, “exhibition facilities”). In recent years, technology has been developed to exhibit works in an exhibition facility provided in a virtual space. For example, Patent Document 1 discloses an image viewing system that guides viewers to a virtual space with image storage compartments. Data for synthesizing an image is generated by a virtual space data generator, and the synthesized image is generated in the virtual space. A reference image is stored in an image memory. A guidance generator is provided to generate data for guiding the viewers from a reference location in the virtual space to another virtual space in which the same or similar image as the reference image is displayed. Guidance data is generated by the guidance generator and is received by a display controller. A guidance image is displayed on a display under the control of the display controller.

### RELATED ART DOCUMENT

### Patent Document

Patent Document 1: Japanese Patent Application Laid-Open Publication No. 2013-50956

### SUMMARY OF THE INVENTION

### Problem to be Solved by the Invention

Creators can rent exhibition spaces in a gallery by paying rental fees. However, the cost of renting a well-known established gallery that attracts many visitors is generally high, and opportunities for exhibition are far from equal. Furthermore, an exhibition in a museum is not held unless the values of the works are recognized by museum operators. As a result, creators with a limited track record have little opportunity for exhibition in a museum. This also applies to galleries and museums in virtual spaces.

An object of the present invention is to allow more creators to have opportunities for exhibitions of their works.

### Means of Solving the Problems

A virtual space management apparatus according to one aspect of the present invention is a virtual space management apparatus that displays on a terminal device used by a user, a virtual space in which images are arranged. The images correspond to works created by creators. The creators include a first creator. The virtual space management apparatus includes: a display controller configured to display, in a first region that is a region within the virtual space assigned to the first creator, a first image representing a first work that is one among a first work group created by the first creator; and a detector configured to detect a motion of the user viewing the first image. Based on the motion of the user, the display controller displays, in the first region, a second image representing a second work that differs from the first work among the first work group.

### Effect of the Invention

According to one aspect of the present invention, it is possible to allow more creators to have opportunities to exhibit their works.

### BRIEF DESCRIPTION OF THE DRAWINGS

FIG. 1 is a block diagram illustrating a configuration of a system 1 according to an embodiment.

FIG. 2 is a block diagram illustrating a configuration of a user terminal 20.

FIG. 3 is a block diagram illustrating a configuration of a server 10.

FIG. 4 is a diagram illustrating an example of a virtual space image VP.

FIG. 5 is a diagram illustrating an example of the virtual space image VP.

FIG. 6 is a diagram illustrating an example of the virtual space image VP.

FIG. 7 is a diagram schematically illustrating a change in a location of a first region SP1.

FIG. 8 is a flowchart illustrating an operation of a processor 103.

FIG. 9 is a diagram illustrating a first modification.

MODES FOR CARRYING OUT THE INVENTION

### A. First Embodiment

### A-1. System Configuration

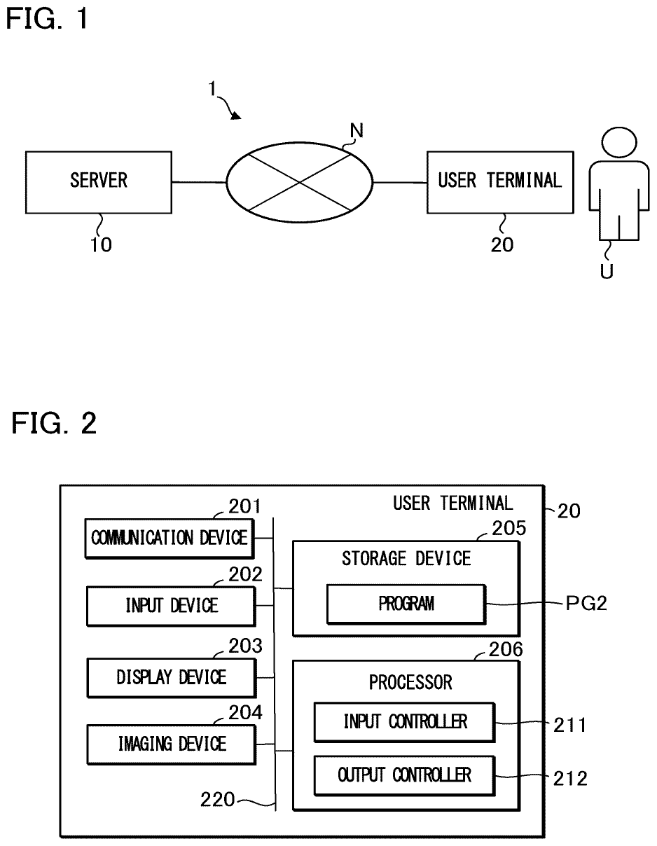

FIG. 1 is a block diagram illustrating a configuration of a system 1 according to an embodiment. The system 1 includes a server 10 and a user terminal 20. The server 10 and the user terminal 20 are connected via a network N.

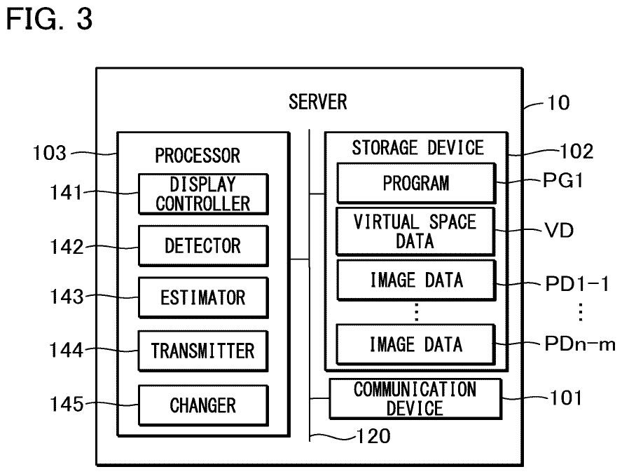

The server 10 is an example of a virtual space management apparatus, and it manages a virtual space. More specifically, the server 10 manages virtual space data VD and image data PD (PD1-1 to PDn-m, see FIG. 3). These data are used to display on the user terminal 20, a virtual space (gallery G) in which images are arranged.

The user terminal 20 is an example of a terminal device used by a user U. The user terminal 20 is an information processing terminal, such as a smartphone, a tablet terminal, a personal computer, or a head-mounted display. FIG. 1 shows a single user terminal 20; however, the system 1 may include more than one user terminal 20.

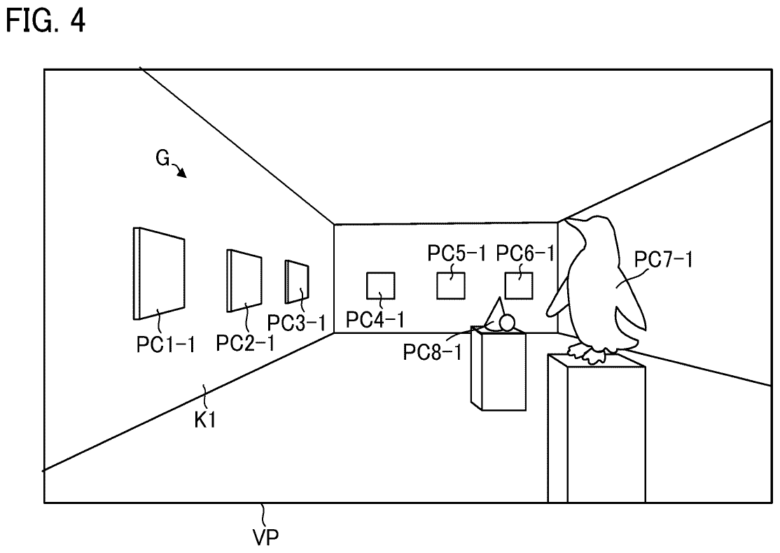

The system 1 displays the virtual space on the user terminal 20 to allow the user U to have various experiences in the virtual space. In the present embodiment, description will primarily be given in which the user U views works in a gallery G (see FIG. 4) provided in the virtual space.

The user U acts through an avatar within the virtual space. The virtual space image VP displayed on the user terminal 20 represents the avatar's field of view. Hereinafter, the avatar of the user U is referred to as a “user avatar.” Alternatively, the user avatar may be shown within the virtual space image VP by setting the user viewpoint in the vicinity of the user avatar therewithin. The user U operates the user terminal 20 to move the user avatar within the virtual space and view works in the gallery G.

### A-2. User Terminal 20

FIG. 2 is a block diagram illustrating a configuration of the user terminal 20. The user terminal 20 includes a communication device 201, an input device 202, a display device 203, an imaging device 204, a storage device 205, a processor 206, and a bus 220 that connects these devices to each other.

The communication device 201 communicates with the server 10 using wireless or wired communication. In the present embodiment, the communication device 201 includes an interface connectable to the network N, and communicates with a communication device 101 of the server 10 (see FIG. 3) via the network N.

The input device 202 receives user inputs from a device, such as a keyboard, a mouse, switches, buttons, a microphone, and a sensor. The display device 203 displays information on a variety of types display panels, such as a liquid crystal display panel, and an organic EL display panel. The display device 203 and the input device 202 may be integrated like in a touch panel.

When the user terminal 20 is a head mounted display, a projection device is provided to project an image onto lenses positioned in front of both eyes of the user U instead of the display device 203.

The imaging device 204 generates user images, which are captured images of the user U. If the user terminal 20 is a smartphone, a tablet terminal, or a personal computer, the imaging device 204 may be a built-in camera device facing the user U. If the user terminal 20 is a head-mounted display, the imaging device 204 may be a line-of-sight detecting camera.

The storage device 205 is a recording medium readable by the processor 206. The storage device 205 includes a nonvolatile memory and a volatile memory. Examples of the nonvolatile memory include a read only memory (ROM), an erasable programmable read only memory (EPROM), and an electrically erasable programmable read only memory (EEPROM). Examples of the volatile memory include a random access memory (RAM). The storage device 205 stores a program PG2 that runs the user terminal 20.

The processor 206 has one or more central processing units (CPUs). The one or more CPUs are examples of one or more processors. Each processor and the CPUs are examples of a computer.

The processor 206 reads the program PG2 from the storage device 205. The processor 206 acts as an input controller 211 and an output controller 212 by executing the program PG2. At least one of the functions of the input controller 211 and the output controller 212 may be a circuit, such as a digital signal processor (DSP), an application specific integrated circuit (ASIC), a programmable logic device (PLD), or a field programmable gate array (FPGA).

The input controller 211 transmits to the server 10, information input by the input device 202 (hereinafter, “input information”). The input information may instruct a direction of movement of the user avatar within the virtual space, or it may be a captured image of the user U.

The output controller 212 outputs to the display device 203, information transmitted from the server 10 (hereinafter, “output information”). For example, the output information may be a virtual space image VP. When the user terminal 20 includes a speaker, the output controller 212 may control audio output from the speaker.

### A-3. Server 10

FIG. 3 is a block diagram illustrating a configuration of the server 10. The server 10 includes the communication device 101, a storage device 102, a processor 103, and a bus 120 that connects these devices to each other.

The communication device 101 communicates with the user terminal 20 using wireless or wired communication. In the present embodiment, the communication device 101 includes an interface connectable to the network N, and communicates with the communication device 201 of the user terminal 20 (see FIG. 2) via the network N.

The storage device 102 is a recording medium readable by the processor 103. The storage device 102 includes a nonvolatile memory and a volatile memory. Examples of the nonvolatile memory include a ROM, an EPROM, and an EEPROM. Examples of the volatile memory include a RAM. The storage device 102 stores a program PG1, the virtual space data VD, and pieces of image data PD (PD-1 to PDn-m, n and m are integers equal to or greater than 2).

The program PG1 is used to operate the server 10. The virtual space data VD is used to display the virtual space including the gallery G on the user terminal 20. The pieces of image data PD1-1 to PDn-m respectively correspond to images PC indicating works exhibited in the gallery G (PC1-1 to PCn-m, see FIG. 4). The images PC1-1 to PCn-m correspond to respective works created by creators. A work created by an n-th creator, who is any one of the creators, is denoted as PCn-j (j is an integer equal to or greater than 1). For example, a work created by a first creator is denoted as PC1-j.

Each work may be a two-dimensional work, such as a painting or an illustration, or it may be a three-dimensional work, such as a sculpture or a ceramic piece. The image data PD1-1 to PDn-m are two-dimensional or three-dimensional data obtained by scanning a work. If a two-dimensional work is digitally drawn, the image data PD1-1 to PDn-m may indicate the two-dimensional work itself.

The processor 103 comprises one or more CPUs, which are examples of processors. Each of the processors and the CPUs is an example of a computer.

The processor 103 reads the program PG1 from the storage device 102. By executing the program PG1, the processor 103 acts as a display controller 141, a detector 142, an estimator 143, a transmitter 144, and a changer 145. At least one of functions of the display controller 141, the detector 142, the estimator 143, the transmitter 144, and the changer 145 may be a circuit, such as a DSP, an ASIC, a PLD, and an FPGA.

### A-4. Details of Processor 103

Description will now be given of the display controller 141, the detector 142, the estimator 143, the transmitter 144, and the changer 145 realized by the processor 103. The gallery G will be described before the description of these functions.

As described above, in the present embodiment, the user U views works in the gallery G provided within the virtual space. Creators' works are exhibited in the gallery G. The creators pay an exhibition fee to an operator of the gallery G, who assigns exhibition spaces in the gallery G to each creator. The creators display their works in their assigned exhibition spaces.

FIG. 4 is a diagram illustrating an example of a virtual space image VP indicating the gallery G. The virtual space image VP includes images PC1-1, PC2-1, PC3-1, PC4-1, PC5-1, PC6-1, PC7-1, and PC8-1. The images PC1-1, PC2-1, PC3-1, PC4-1, PC5-1, PC6-1, PC7-1, and PC8-1 represent the different respective creators' works. The images PC1-1, PC2-1, PC3-1, PC4-1, PC5-1, and PC6-1 represent two-dimensional works, and images PC7-1 and PC8-1 represent three-dimensional works.

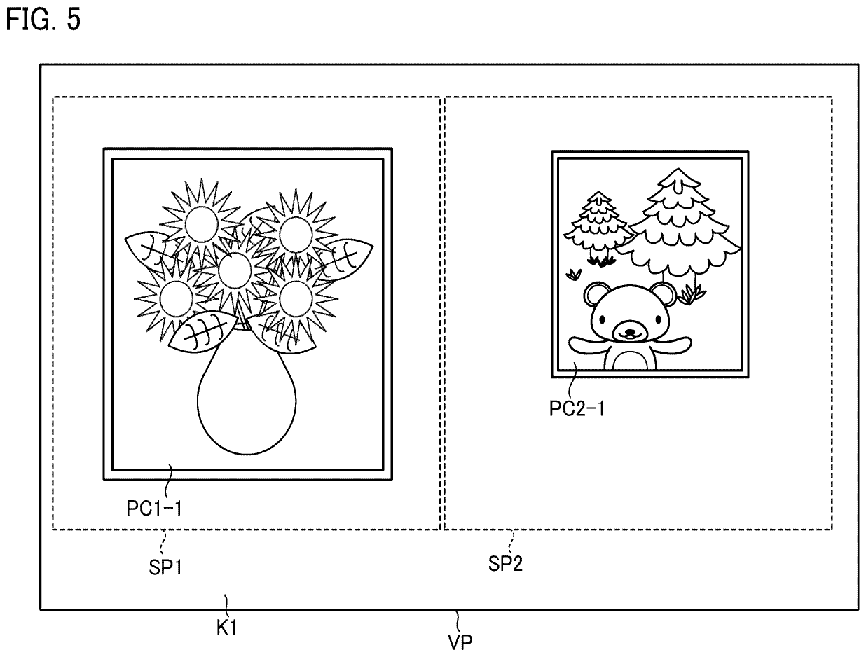

FIG. 5 is a diagram illustrating an example of the virtual space image VP around the images PC1-1 and PC2-1. The image PC1-1 represents a work by a first creator, and the image PC2-1 represents a work by a second creator. A first region SP1, which is a part of a wall surface K1 of the gallery G, is assigned to the first creator. A second region SP2, which a part of the wall surface K1 of the gallery G, is assigned to the second creator.

In FIG. 5, the first region SP1 and the second region SP2 have the same size. However, the creators may have an option to specify the sizes of the regions assigned to them. In this case, the exhibition fee may be determined based on the size of each region. In FIG. 5, the size of the first region SP1 exceeds that of the image PC1-1. However, the first region SP1 may conform to the frame size of the work. When the size of the first region SP1 is less than that of the work represented by the image PC1-1, a reduced image PC1-1 may be displayed. Depending on the size of the work, more than one work may be displayed in the first region SP1. That is, creators can exhibit their works freely within regions SP assigned to them.

In the gallery G within the real space, when the region assigned to each creator is equal in size to a single work, only one work is exhibited in this region. However, in the present embodiment, even when the region assigned to each creator is equal in size to a single work, more than one work can be associated with the region. It is envisaged that one or more works by the first creator form a first work group with corresponding images PC1-1 to PC1-n.

The first creator determines any one of the first work group as “representative work.” The representative work is first to be displayed in the region SP assigned to each creator. The representative work by the first creator is referred to as “first work.” For example, the first creator selects a first work that the creator is the most confident exhibiting or desires to be viewed by many visitors. It is envisaged that the first creator selects a work corresponding to the image PC1-1 as the first work. The image PC1-1 is an example of the first image. Furthermore, the first creator also determines a display order of works other than the first work. It is envisaged that the first creator has determined to exhibit works in the order of the images PC1-2, P1-3, . . . , and PC1-n. Other creators also determine the representative work and the display order in the same manner. The image indicating the representative work by the h-th creator is PCh-1.

When the user avatar visits the gallery G, images indicating representative works by the creators are respectively displayed in regions assigned to the corresponding creators. For example, as illustrated in FIG. 5, the image PC1-1 corresponding to the representative work by the first creator (first work) is displayed in the first region SP1. The image PC2-1 corresponding to the representative work by the second creator is displayed in the second region SP2.

The user U views the works displayed in the gallery G using the user terminal 20. The server 10 detects a motion of the user U viewing a work. For a predetermined motion of the user U, the server 10 determines that the user U is interested in this work. Then, another work created by the same creator is displayed in the region assigned to this creator. Examples of the predetermined motion include viewing the work for a predetermined duration or more, and a predetermined action.

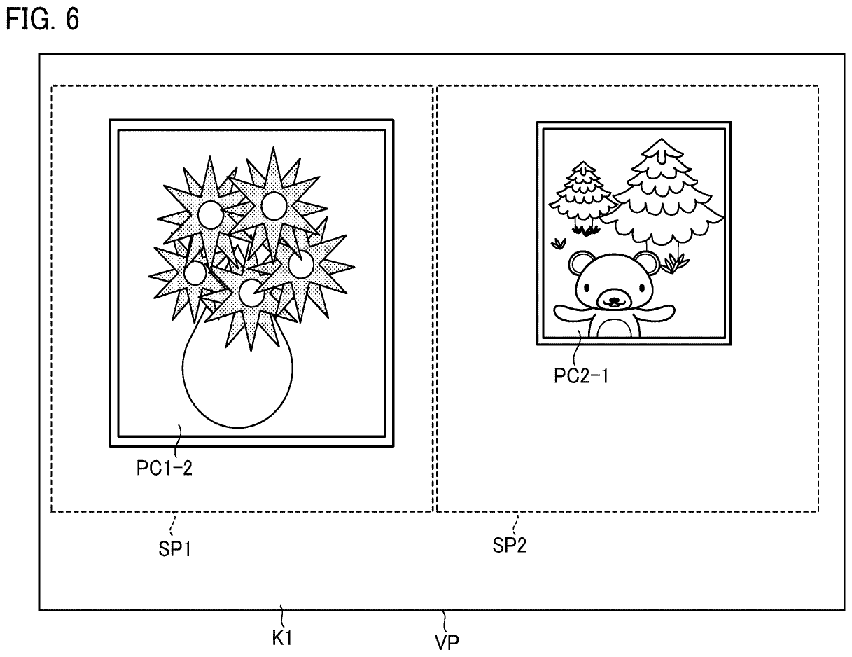

For example, when the user U performs the predetermined motion while viewing the first work by the first creator (image PC1-1), an image representing a second work (for example, the image PC1-2), which differs from the first work in the first work group, is displayed in the first region SP1. In other words, as illustrated in FIG. 6, the image displayed in the first region SP1 is switched from the image PC1-1 to the image PC1-2. Furthermore, when the user U performs another motion while viewing the image PC1-2, an image representing a third work (for example, the image PC1-3), which differs from the first and second works, is displayed in the first region SP1.

As a result, the user U can view other works by the creator, who created the work the user U likes, and can explore the works in depth. Furthermore, since the user U visits the gallery G to view many creators' works, an encounter with a creator that fits the user's preference is likely to occur. Each creator can also acquire an opportunity to exhibit works only by renting one exhibition space, and the cost is reduced as compared to when the creator rents the entire gallery G for an individual exhibition.

Details of each function illustrated in FIG. 3 will be described below.

The display controller 141 generates, based on the virtual space data VD, display data indicating a virtual space image to be displayed on the user terminal 20. More specifically, the display controller 141 specifies a portion of the virtual space included in a range of visual field of the user avatar based on a position (including the direction of the line of sight) of the user avatar in the virtual space. The display controller 141 generates image data indicating the portion of the virtual space as the display data.

When the user avatar is positioned in the gallery G, the display controller 141 generates display data indicating the gallery G. Immediately after the user avatar enters the gallery G, representative works by the creators are displayed in the respective regions assigned to them. Specifically, as illustrated in FIG. 5, the display controller 141 displays in the first region SP1, the image PC1-1 of the first work that is one of the pieces in the first work group created by the first creator. The first region SP1 is a region of the virtual space assigned to the first creator.

The detector 142 detects a motion of the user U viewing the image displayed in the gallery G. For example, when the user U views the image PC1-1, the detector 142 detects a motion of the user U viewing the image PC1-1. On the basis of the motion of the user U, the display controller 141 displays in the first region SP1, the image of the second work, which differs from the first work in the first work group. For example, as illustrated in FIG. 6, the display controller 141 displays in the first region SP1, the image PC1-2 of the second work different from the image PC1-1.

For example, the detector 142 detects a time period for which the user U is viewing the image PC1-1. Specifically, the detector 142 obtains an image captured by the imaging device 204 of the user terminal 20 and measures a time period the user U is viewing a screen (the display device 203) on which the image PC1-1 is displayed.

The display controller 141 displays the image PC1-2 in the first region SP1 when the time period for which the user U is viewing the image PC1-1 is equal to or greater than the predetermined duration. When the user U views the image PC1-1 for a long time, it is supposed that the user U is interested in the work of the image PC1-1. Displaying the second work (image PC1-2) by the first creator, who created the work of the image PC1-1, helps the user U gain a deeper understanding of the first creator's artistic vision.

The detector 142 may detect a motion of the user avatar. The input device 202 of the user terminal 20 receives an input, and the detector 142 detects a motion of the user avatar based on an input operation for instructing the user avatar to move.

When the user avatar makes a predetermined motion, the display controller 141 displays the image PC1-2 in the first region SP1. The predetermined motion is in accordance with swiping the image PC1-1 left, right, up and down. The predetermined motion may be notified to the user U. For example, when the user U enters the gallery G, the following announcement may be displayed: “If you like the work, swipe to see another work by the same creator.” This allows the user U to switch the work at any time, and convenience is improved.

The estimator 143 estimates evaluation by the user U for a work based on a reaction of the user U who has viewed the image of the work. For example, the estimator 143 estimates evaluation by the user U for the first work based on a reaction of the user U who has viewed the image PC1-1. The reaction of the user U indicates user U's facial expression or spoken voice. The estimator 143 estimates an evaluation by the user U for the work using a machine learning model and an image captured by the imaging device 204 of the user terminal 20. The machine learning model is a model that learns a relationship between images of a person's facial expressions and emotions. Furthermore, the estimator 143 analyzes the spoken voice of the user U and estimates the evaluation by the user U for the work. Examples of the evaluation for the work by the user U include a classification (e.g., “like/dislike/neither,” and a value (e.g., “50% likability.”

The transmitter 144 transmits the evaluation estimated by the estimator 143 to a terminal device of the first creator. By transmitting the user U's evaluation after viewing the work, the creator can obtain feedback such as whether the work is accepted by the user U, or whether the intention of the work by the creator is conveyed to the user. The transmitter 144 may transmit not only the evaluation estimated by the estimator 143 but also comments or evaluation on the work received from the user U. Alternatively, the spoken voice of the user U may be directly converted into text, and the text may be transmitted to the creator.

The changer 145 periodically changes a location of the region assigned to each creator in the gallery G. For example, the changer 145 periodically changes a location of the first region SP1 in the gallery G. This change is made because there are two areas in the gallery G: a location that visitors can easily view, and a location that is harder for visitors to notice. For example, a work displayed farther from the entrance (for example, the image PC6-1 shown in FIG. 4) may attract fewer visitors than a work displayed near the entrance (for example, the image PC1-1 shown in FIG. 4). Possible reasons for this include leaving the gallery G due to the visitors running out of time after spending too much time viewing works near the entrance, and overlooking works due to the layout of the gallery G.

When the creators pay the same exhibition fee, it is undesirable if the number of viewers is not balanced depending on the exhibition location. Therefore, the changer 145 periodically rotates the locations of the regions assigned to the creators in the gallery G to ensure fairness among the creators. When visitor patterns in the gallery G vary by time, or day of the week, the rotation interval and order may be determined accordingly. Furthermore, movements of the visitors in the gallery G may be analyzed, and the rotation interval and the order may be determined accordingly.

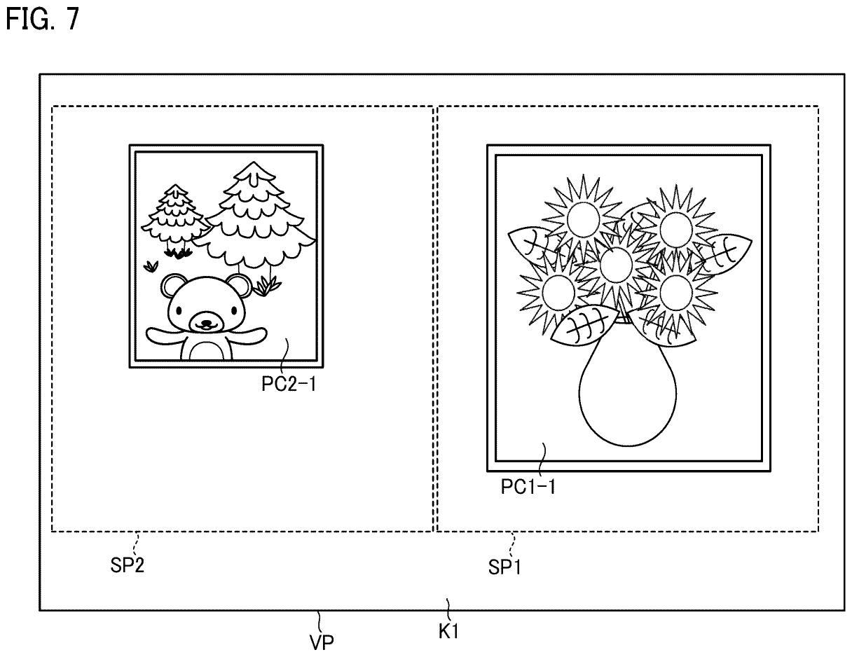

FIG. 7 is a diagram schematically illustrating a change in the location of the first region SP1. In FIG. 5, when viewed from the user avatar facing the wall surface K1, the first region SP1 is on the left, and the second region SP2 is on the right. In contrast, in FIG. 7, when viewed from the user avatar facing the wall surface K1, the first region SP1 is on the right, and the second region SP2 is on the left. For convenience of illustration, the locations of the two regions SP (the first region SP1 and the second region SP2) are interchanged in FIG. 7. However, actually, the locations of a large number of regions SP in the gallery G are interchanged.

If the arrangement in the gallery G changes while the user U is viewing the exhibition, it is difficult for the user U to know which works have not been viewed. Therefore, it is preferable, for one user U, to maintain the display layout from the time at which the user U enters the gallery G. In the gallery G within the virtual space, it is possible to display different exhibition layouts for the respective users U.

### A-5. Operation of Processor 103

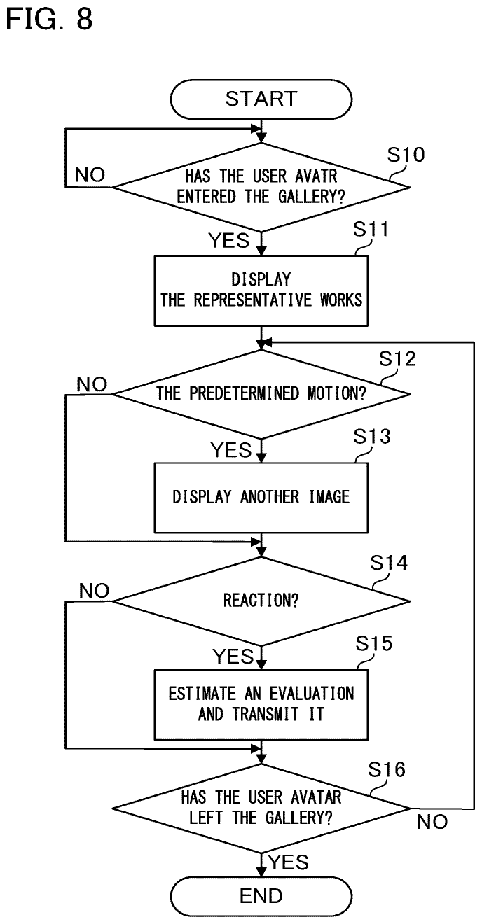

FIG. 8 is a flowchart illustrating an operation of the processor 103. The processor 103 of the server 10 acts as the display controller 141 and waits until the user avatar enters the gallery G within the virtual space (step S10: NO). When the user avatar enters the gallery G (step S10: YES), images PC of the representative works by the respective creators are displayed in the regions SP (step S11).

The processor 103 acts as the detector 14, and it detects a motion of the user U who is viewing the image PC displayed in the gallery G. When the user U has performed a predetermined motion (step S12: YES), the processor 103 acts as the display controller 141 and displays another image PC created by the same creator in the region SP being viewed by the user U (step S13). When the user U has not made the predetermined motion (step S12: NO), the processor 103 advances the processing to step S14.

The processor 103 acts as the estimator 143 and determines whether the user U, after viewing the image PC, has shown a reaction, such as a change in facial expression or voice (step S14). When the user U shows a reaction (step S14: YES), the processor 103 acts as the estimator 143 and estimates the evaluation by the user U for the work. The processor 103 acts as the transmitter 144 and transmits the estimated evaluation to the creator's terminal (step S15). When the user U does not show any reaction (step S14: NO), the processor 103 advances the processing to step S16.

Until the user avatar leaves the gallery G (step S16: NO), the processor 103 returns the processing to step S12 and repeats the subsequent processing. When the user avatar leaves the gallery G (step S16: YES), the processor 103 ends the processing of this flowchart.

As described above, the server 10 according to the embodiment displays in the first region SP1 of the virtual space assigned to the first creator, an image PC1-1 representing a first work that is one piece among the first work group created by the first creator. The server 10 detects a motion of the user U viewing the image PC1-1. Based on the motion of the user U, the server 10 displays in the first region SP1, an image PC1-2 representing a second work that differs from the first work. As a result, as compared with when the exhibited images PC (works) remain unchanged, the space of the gallery G can be lent to many creators, providing exhibition opportunities at a lower cost. If the user U visits the gallery once, the user U may be exposed to works by many creators and can explore works in depth by these creators the user finds interesting.

When the user U is viewing an image PC1-1 for a predetermined duration or more, the server 10 displays another image PC1-2 in the first region SP1. If the user U is viewing the image PC1-1 for a predetermined duration or more, the user U is supposed to be interested in the image PC1-1. As a result, there is a high probability that the user U will also be interested in the image PC1-2 of the second work by the first creator who created the work of the image PC1-1. By using the time period of viewing the image PC1-1, it is possible to estimate whether the user U is interested with a minimal processing load.

When the user U performs a predetermined motion, the server 10 displays another image PC1-2 in the first region SP1. By switching the image to be displayed in the first region SP1 based on the motion of the user U, the user U can determine when the image PC is changed, which enhances the convenience of the user U.

The server 10 estimates, based on the reaction of the user U who has viewed the image PC1-1, the evaluation by the user U for the first work of the image PC1-1, and transmits the evaluation to the terminal device of the first creator. As a result, the first creator can gain insight into the user U's evaluation of the first work. This results in support for the user's creative activities.

The server 10 periodically changes the location of the first region SP1 in the virtual space. That is, the server 10 periodically changes the region SP assigned to each creator. As a result, an imbalance, such as a difference in prominence depending on the exhibition location, is prevented, and the creators can have equal opportunities to exhibit their works.

### B: Modification

Modifications of the foregoing embodiment will be described below. Two or more modifications freely selected from the following modifications may be combined as long as they do not conflict.

### B1: First Modification

In the foregoing embodiment, the images PC displayed in the first region SP1 are switched in the order defined by the first creator. However, the method of changing the image PC displayed in the first region SP1 is not limited thereto. For example, it is possible to sequentially display the works that the user U desires to view.

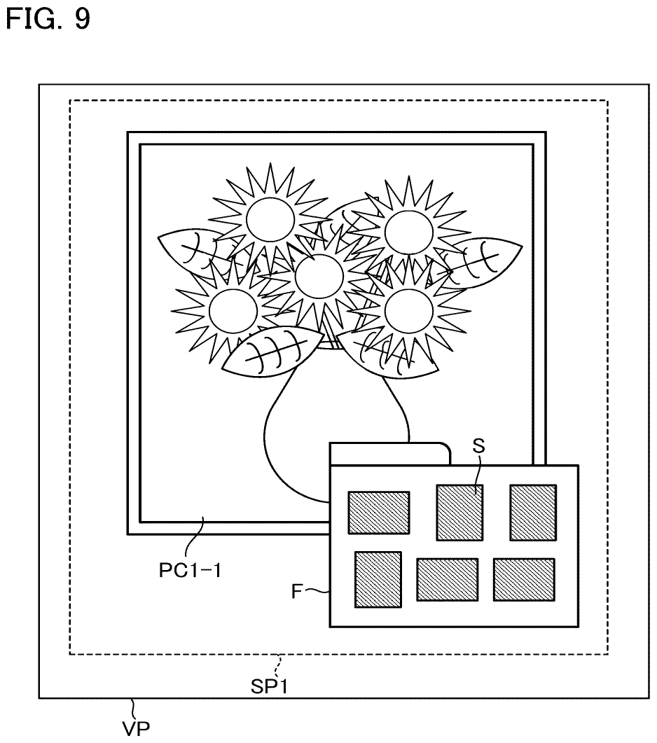

FIG. 9 is a diagram illustrating a first modification. When the user U viewing an image PC1-1 performs a predetermined motion (for example, the user is viewing the image PC1-1 for a predetermined duration or more), a folder image F is displayed in the first region SP1. Within the folder image F, one or more thumbnail images S of other works created by the first creator are displayed. Each thumbnail image S is a reduced image PC showing a work created by the first creator.

When the user U (user avatar) taps any one of the thumbnail images S, an image PC corresponding to the tapped thumbnail image S is displayed in the first region SP1 (for example, a portion at which the image PC1-1 is displayed, as shown in FIG. 7). As a result, the user U can preferentially view a work of particular interest among the works created by the first creator. For example, when the works by the first creator can be classified into series (groups of consecutive works), folders may be made hierarchical so that the works can be organized for each series.

According to this modification, the user U can determine the display order of the images PC, which enhances convenience for the user U. The creator can obtain data to analyze which of the creator's works is most likely to attract the interest of the user U.

For example, when the user U who is viewing the image PC1-1 performers a predetermined motion, a user interface for switching the display image (for example, a switching button) may be displayed in the first region SP1. When the user U desires to view another work by the first creator, the user U inputs to the input device 202 to cause the user avatar to press the switch button. In this way, the user U can determine when the image PC is displayed in the first region SP1 and can view the work at the user U's own pace.

### B2: Second Modification

In the foregoing embodiment, the exhibit location of the work in the gallery G, that is, the location of the region assigned to each creator is periodically changed. This is because the exhibition fee paid by the creator to the operator of the gallery G is basically the same (a pay-per-use system according to the size of the region).

The exhibition fee may change according to various conditions. For example, the exhibition fee may change based on the display location of the work in the gallery G. For example, a high fee may be set for a prominent location (such as near the entrance, although this depends on the gallery layout), whereas a low fee may set for a less visible location. An exhibition fee corresponding to a time period may be set. For example, the exhibition fee may be set high on Saturday and Sunday, or during the evening, when a large number of visitors can be expected (a time period corresponding to primetime in the broadcasting industry), and the exhibition fee may be set low during the daytime or early morning on weekdays.

According to the second modification, the exhibition fee is changed based on the display location and the time period in the gallery G. As a result, creators can benefit according to their financial location. For example, a financially independent creator can exhibit works at a location or a time period that easily attracts the attention of visitors. A creator with limited financial resources can select a location or a time period at which works can be exhibited at a lower exhibition fee.

### B3: Third Modification

In the foregoing embodiment, description is given of the gallery G as an exhibition facility. However, the exhibition facility is not limited to the gallery G. For example, the exhibition facility may be a museum. When works by creators of the same era are exhibited in a museum, one region is assigned to one creator. In an initial state, the representative work by each creator is displayed. When the user U viewing the work performs a predetermined motion, another work by the same creator is displayed. Furthermore, for example, when a work exhibition of one creator is held in a museum, the works by the creator are classified into work groups. The classification of the work group may be based on eras of creation or be in series (consecutive works). One region is assigned to one work group. In an initial state, the representative work by each work group is displayed. When the user U viewing the work performs a predetermined motion, another work by the same work group is allowed to be displayed.

As illustrated in the third modification, the system 1 is applicable to various types of exhibition facilities.

### C: Other Matters

(1) In the foregoing embodiment, a read only memory (ROM) and a random access memory (RAM) are exemplified as the storage devices 102 and 205, but the storage devices 102 and 205 may be flexible disks, magneto-optical disks (for example, compact discs, digital versatile discs, or Blu-ray (registered trademark) discs), smart cards, flash memory devices (for example, cards, sticks, or key drives), compact disc-ROMs (CD-ROMs), registers, removable disks, hard disks, floppy (registered trademark) disks, magnetic strips, databases, servers, or other appropriate storage media.
(2) In the foregoing embodiments, the described information, signals, and the like may be represented using any of a variety of different technologies. For example, data, instructions, commands, information, signals, bits, symbols, chips, and the like that may be mentioned throughout the above description may be represented by voltages, currents, electromagnetic waves, magnetic fields or particles, optical fields or photons, or any combination thereof.
(3) In the foregoing embodiments, the input/output information and the like may be stored in a specific location (for example, a memory) or may be managed using a management table. The input/output information and the like can be overwritten, updated, or additionally written. The output information and the like may be deleted. The input information and the like may be transmitted to another device.
(4) In the foregoing embodiments, the determination may be performed using a value (0 or 1) represented by using one bit, may be performed using a Boolean value (true or false), or may be performed by comparison of numerical values (for example, comparison with a predetermined value).
(5) The order of the processing procedure, sequence, flowchart, and the like illustrated in the embodiments described above may be changed as long as there is no contradiction. For example, for the methods described in the present disclosure, elements of various steps are presented using an example order, and are not limited to the particular order presented.
(6) Each function illustrated in FIGS. 2 and 3 is implemented by an arbitrary combination of at least one of hardware or software. A method for implementing each functional block is not particularly limited. That is, each functional block may be implemented by using one physically or logically combined device, or may be implemented by directly or indirectly (for example, in a wired or wireless manner) connecting two or more physically or logically separated devices and using the devices. The functional block may be implemented by combining software with the one or more devices.
(7) The program exemplified in the embodiments described above should be interpreted broadly to mean an instruction, an instruction set, a code, a code segment, a program code, a program, a subprogram, a software module, an application, a software application, a software package, a routine, a subroutine, an object, an executable file, an execution thread, a procedure, a function, or the like, regardless of whether the program is referred to as software, firmware, middleware, microcode, or a hardware description language, or referred to by another name.

Software, instructions, information, and the like may be transmitted and received via a transmission medium. For example, when software is transmitted from a website, server, or other remote source using at least one of a wired technology (a coaxial cable, an optical fiber cable, a twisted pair, a digital subscriber line (DSL), or the like) or a wireless technology (infrared rays, microwaves, or the like), at least one of the wired technology or the wireless technology is included within the definition of the transmission medium.
(8) In the foregoing embodiment, the terms “system” and “network” are used interchangeably.
(9) The information, the parameter, or the like described in the present disclosure may be represented by using an absolute value, may be represented by using a relative value from a predetermined value, or may be represented by using another corresponding information.
(10) In the foregoing embodiment, the terminal device is a mobile station (MS). The mobile station may also be referred to by those skilled in the art as a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable term. In the present disclosure, the terms such as “mobile station”, “user terminal”, “user equipment (UE)”, and “terminal” can be used interchangeably.
(11) In the foregoing embodiment, the terms “connected”, “coupled”, or any variation thereof, mean any direct or indirect connection or coupling between two or more elements, including the presence of one or more intermediate elements between two elements that are “connected” or “coupled” to each other. The coupling or connection between the elements may be physical coupling or connection, logical coupling or connection, or a combination thereof. For example, “connection” may also be read as “access.” When used in the present disclosure, two elements may be “connected” or “coupled” to each other using at least one of one or more wires, cables, or printed electrical connections, and using electromagnetic energy having a wavelength in a radio frequency region, a microwave region, and a light (both visible and invisible) region, and the like as some non-limiting and non-exhaustive examples.
(12) In the foregoing embodiment, the phrase “based on” does not mean “based only on” unless explicitly stated otherwise. In other words, the phrase “based on” means both “based only on” and “based at least on”.
(13) The term “determining” used in the present disclosure may encompass a wide variety of operations. The term “determining” can include, for example, judging, calculating, computing, processing, deriving, investigating, looking up, searching, inquiring (for example, looking up in a table, a database, or another data structure), and ascertaining that can be considered as “determining.” The “determining” can include receiving (for example, receiving information), transmitting (for example, transmitting information), inputting, outputting, and accessing (for example, accessing data in a memory) that can be considered as “determining.” The “determining” can include resolving, selecting, choosing, establishing, and comparing that can be considered as “determining.” That is, “determining” can include any operation that can be considered as “determining.” The “determining” may be read as “assuming”, “expecting”, “considering”, or the like.
(14) In the foregoing embodiments, when the terms “include”, “including”, and variations thereof are used, the terms are intended to be inclusive in the same manner as the term “comprising.” The term “or” used in the present disclosure is intended not to be an exclusive OR.
(15) In the present disclosure, for example, when articles such as “a”, “an”, and “the” in English are added by translation, the present disclosure may include a case in which a noun following these articles is a plural form.
(16) In the present disclosure, the expression “A and B are different” may mean that “A and B are different from each other.” The term may mean that “A and B are different from C.” The terms such as “separated”, “coupled” and the like may also be interpreted in the same manner as “different”.
(17) The foregoing aspects and embodiments in the present disclosure may be used alone, or may be used in combination, or may be switched with execution. Notification of predetermined information (for example, notification of “being X”) is not limited to notification performed explicitly, and may be performed implicitly (for example, notification of the predetermined information is not made).

The selected modifications may be combined.

### DESCRIPTION OF REFERENCE SIGNS

1 . . . system, 10 . . . server, 20 . . . user terminal, 101 . . . communication device, 102 . . . storage device, 103 . . . processor, 141 . . . display controller, 142 . . . detector, 143 . . . estimator, 144 . . . transmitter, 145 . . . changer, G . . . gallery, N . . . network, PC (PC1-1 to PCn-m) . . . image, PD (PD1-1 to PDn-m) . . . image data, SP . . . region, SP1 . . . first region, SP2 . . . second region, U . . . user, VD . . . virtual space data, VP ... virtual space image.

1. A virtual space management apparatus that displays on a terminal device used by a user, a virtual space in which a plurality of images is arranged, the plurality of images corresponding to a plurality of works created by a plurality of creators, the plurality of creators including a first creator, the virtual space management apparatus comprising:
a display controller configured to display in a first region that is a region within the virtual space assigned to the first creator, a first image representing a first work that is one among a first work group created by the first creator; and
a detector configured to detect a motion of the user viewing the first image,
wherein based on the motion of the user, the display controller displays, in the first region, a second image representing a second work that differs from the first work among the first work group.

2. The virtual space management apparatus according to claim 1, wherein:
the detector detects a time period for which the user is viewing the first image, and
the display controller displays, in the first region, the second image, when the time period is equal to or greater than a predetermined time.

3. The virtual space management apparatus according to claim 1, wherein:
the user acts through an avatar within the virtual space,
the detector detects a motion of the avatar, and
the display controller displays in the first region, the second image, when the avatar performs a predetermined motion.

4. The virtual space management apparatus according to claim 1, further comprising:
an estimator configured to estimate an evaluation for the first work by the user based on a reaction of the user viewing the first image; and
a transmitter configured to transmit the evaluation estimated by the estimator to a terminal device used by the first creator.

5. The virtual space management apparatus according to claim 1, further comprising:
a changer configured to periodically change a location of the first region within the virtual space.
